(19) United States
(12) Patent Application Publication
(10) Pub. No.: US 2011/0256275 A1
(43) Pub. Date: Oct. 20, 2011

(54) Edible taco style food shell

(76) Inventor: John P. Gillig, Pompano Beach, FL (US)

(21) Appl. No.: 13/135,060

(22) Filed: Jun. 27, 2011

Related U.S. Application Data
(63) Continuation-in-part of application No. 29/386,445, filed on Mar. 1, 2011.
Application No. 29/386,445 is a continuation-in-part of application No. 29/315,680, filed on Jul. 15, 2009, now Pat. No. D634098.

(51) Int. Cl. A21D 13/00

(52) U.S. Cl. 426/138

(57) ABSTRACT

A taco style shell for maintaining taco and other food ingredients within a defined space includes a pair of spaced apart sidewalls. The pair of sidewalls includes a first sidewall and a second sidewall interconnected by a taco shell base plus one vertical wall. Further, a generally rectangular sidewall barrier is connected to the taco shell base, the first sidewall and the second sidewall, thereby forming the defined space for maintaining the taco and other food ingredients therebetween. A taco style shell for maintaining taco and other food ingredients within a defined space includes a pair of spaced apart sidewalls. The pair of sidewalls includes a first sidewall and a second sidewall interconnected by a taco shell base and one end wall.

### REFERENCE TO RELATED APPLICATION

This application is a continuation-in-part of application Ser. No. 29/386,445, filed Mar. 1, 2011, which application is a continuation-in-part of application Ser. No. 29/315,680, now Design Pat. No. D634,098. All parent applications are incorporated into their entirety.

### FIELD OF THE INVENTION

Embodiments of the present invention generally relate to food items, and, more particularly, to taco style shells for maintaining taco and other ingredients within a defined space.

### BACKGROUND OF THE INVENTION

In recent scenario, consumers are searching for healthy and yet convenient food options, avoiding foods which are not easy to carry in hand while doing any activity. Lebanese breads and pita pockets are used as a carrier for toppings or sandwich ingredients. Yet, they can leak from all directions, and are likely to break while consumers attempt to fold them into shapes that are convenient to hold and carry. Tacos have always been all time favorite food for all age groups. However, while eating a taco the consumer might experience breaking leaking and ingredients spilling around.

The prior art, as known to the inventor, consists of U.S. Pat. No. 5,009,902 (1999) to Mercenari; and U.S. Patent Application Publication US 2008/0193613(2008) to Kovich et al, as well as my Design Pat. No. D634,098 (2011), entitled Pre-Formed Taco Shell; U.S. Design Pat. No. D634,099 (2011), entitled Edible Shell for Holding of Comestible Products; and Design Pat. No. D624,277 (2010), entitled Taco Shell.

Accordingly, there remains a need in the art to form a taco style shell to retain the taco and other ingredients within the defined space of the taco style shell while being eaten by a consumer.

### SUMMARY OF THE INVENTION

In one embodiment of the present invention, a taco style shell for maintaining taco and other ingredients within a defined space is disclosed. The taco style shell includes a pair of spaced apart sidewalls flaring outward from an imaginary longitudinal plane. The pair of sidewalls includes a first sidewall and a second sidewall interconnected by a taco shell base. Further, an integral end wall is connected to the taco shell base, the first sidewall and the second sidewall, thereby forming the defined space for maintaining the taco and other ingredients there between.

In another embodiment of the present invention, a taco style shell for maintaining taco and other ingredients within a defined space includes a pair of spaced apart sidewalls and a covering wall barrier portion. The pair of sidewalls includes a first sidewall and a second sidewall interconnected by a taco shell base. The covering wall barrier portion includes a first projection, a second projection and a wall barrier flat portion. The first projection and the second projection are interconnected to each other by the wall barrier flat portion, thereby defining a covering space. Further, the first projection of the covering wall barrier portion partially encloses the first sidewall of the pair of sidewalls, and the second projection of the covering wall barrier portion partially encloses the second sidewall of the pair of sidewalls. The wall barrier flat portion of the covering wall barrier portion is connected to an outer circumference surface of the taco shell base at a distal end of the taco style shell, thereby forming the defined space for maintaining the taco and other ingredients there between.

In yet another embodiment of the present invention, a taco style shell for maintaining taco and other ingredients within a defined space includes a partially circular shell forming portion being foldable about a midline thereof and sealed at a distal end of the taco style shell, thereby forming the defined space for maintaining the taco and other ingredients therebetween. Further, a proximal end of the taco style shell is open.

It is thus an object of the invention to provide a taco shell that includes a mechanism for maintaining the taco ingredients within the ingredient cavity of the taco shell while the taco is eaten.

It is a further object of the invention to provide a taco shell blank formed from a conventional taco shell dough and including a shell portion, a rectangular end barrier portion integrally formed along a section of the perimeter edge of the portion; and a crease line formed between the shell portion and the barrier portion; a shell portion of the taco shell blank being foldable about a midline thereof that runs through the rectangular end barrier portion to form an ingredient pocket; the rectangular barrier portion being foldable at a crease line and into position across the side end opening of the ingredient pocket.

It is still a further object of the invention to provide a taco shell that accomplishes both of the above objects in combination.

The above and yet other objects and advantages of the present invention will become apparent from the hereinafter set forth Brief Description of the Drawings, Detailed Description of the invention and Claims appended herewith.

### BRIEF DESCRIPTION OF THE DRAWINGS

FIG. 1 is a perspective view of a taco style shell, according to one embodiment of the invention.

FIG. 2 is a perspective view of a taco style shell, according to another embodiment of the invention.

FIG. 3 is a perspective view of a taco style shell, according to yet another embodiment of the invention.

FIG. 3A is a front view of the taco style shell of FIG. 3, according to one embodiment of the invention.

FIG. 3B is a rear view of the taco style shell of FIG. 3, according to one embodiment of the invention.

FIG. 4 is a perspective view of a taco shell, according to a further embodiment of the invention.

FIG. 5 is a perspective view of a taco style shell, according to a yet further embodiment.

FIG. 6 is a front elevational view of the embodiment of FIG. 5.

FIG. 7 is a rear elevational view of the embodiment of FIG. 5.

### DETAILED DESCRIPTION OF THE INVENTION

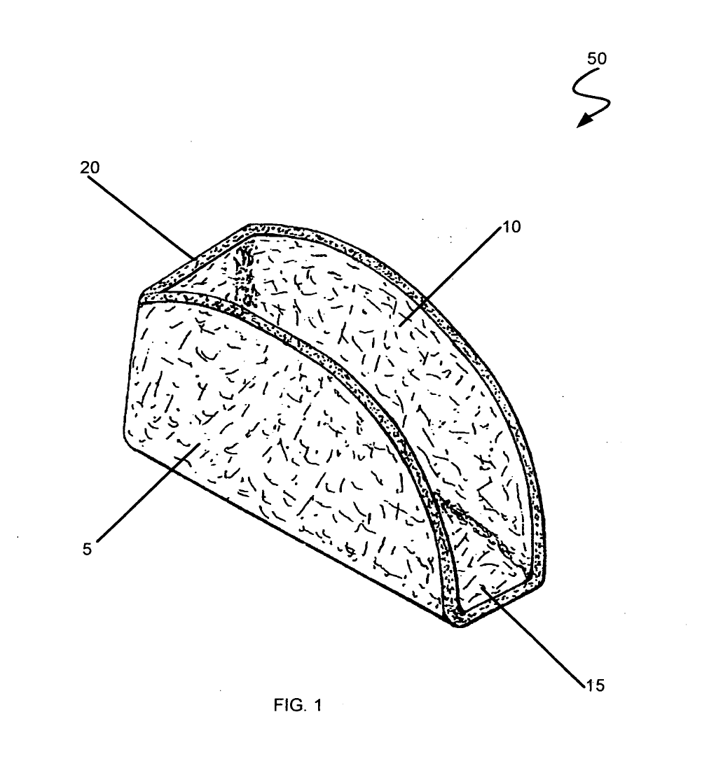

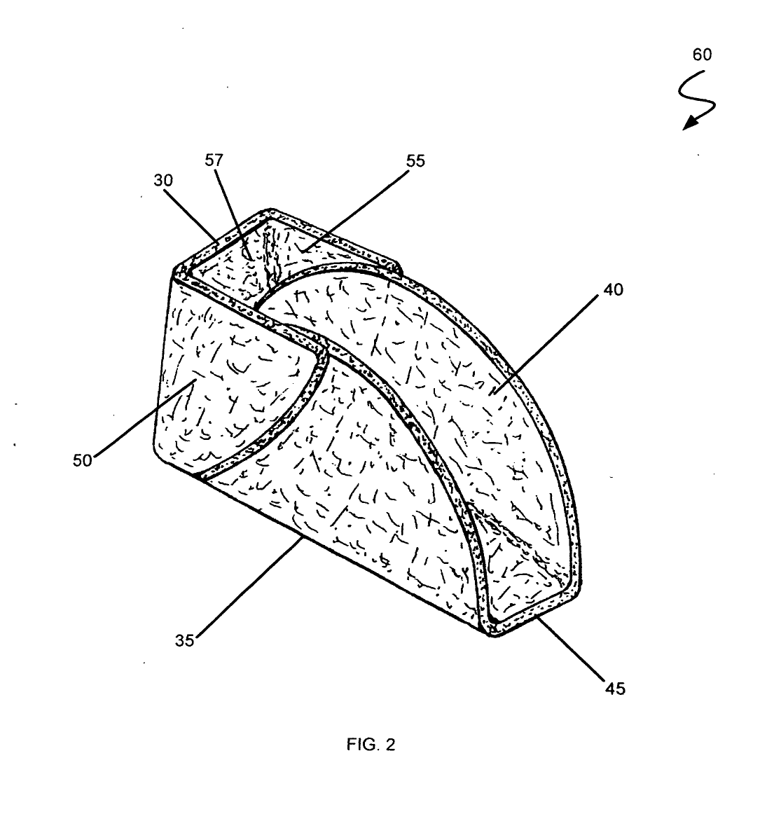

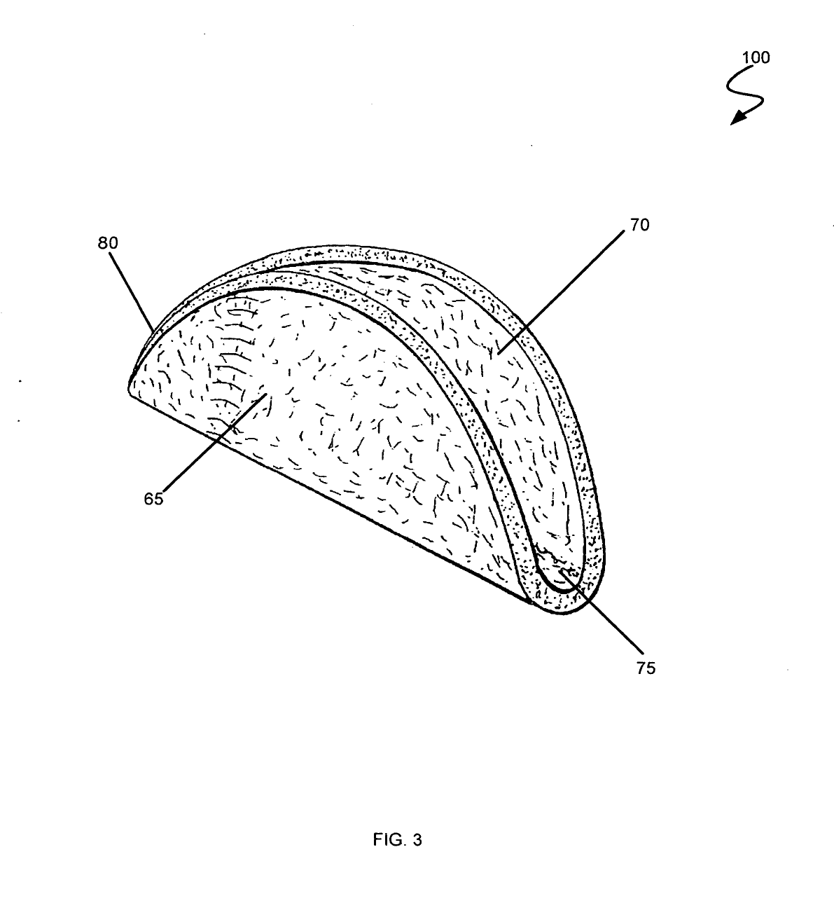

With reference to the perspective view of FIG. 1, in accordance with an embodiment of the present invention, a taco style shell 50 for maintaining taco and other ingredients within a defined space is disclosed. The taco style shell 50 includes a pair of spaced apart sidewalls. The pair of sidewalls includes a first sidewall 5 and a second sidewall 10 interconnected by a taco shell base 15. Further, a rectangular sidewall barrier 20 is connected to the taco shell base 15, the first sidewall 5 and the second sidewall 10, thereby forming the defined space for maintaining the taco and other ingredients therebetween. The taco style shell 50 is formed from any type of bread dough or conventional corn or flour based tortilla dough. Further, the formed defined space of the taco style shell 50 is adapted to receive edible taco and other ingredients not limited Particularly to Taco fillings, the edible taco style shell can be used with ingredients from all food groups and for all day parts, namely, breakfast, lunch, dinner, snacks and desert. The rectangular sidewall barrier 20 connected to the taco style shell base 15, the first sidewall 5 and the second sidewall 10 provides the taco style shell 50 to hold greater amount of taco and other fillings than the conventional taco shells available in the market. This is advantageous because the taco style shell 50 can be filled with greater amounts and variety of meat and other available fillings. Consequently, the present invention taco style shell 50 will be useable for more food groups and day parts then a traditional taco. As an example the Taco style shell can be made with biscuit dough for breakfast, French bread dough for lunch and perhaps Italian dough for dinner with a cinnamon bun dough for a Taco style desert shell.

In another embodiment of the present invention, a taco style shell 60 for maintaining taco and other ingredients within a defined space includes a pair of spaced apart sidewalls and a covering wall barrier portion 30. The pair of sidewalls includes a first sidewall 35 and a second sidewall 40 interconnected by a taco shell base 45. The covering wall barrier portion 30 includes a first projection 50, a second projection 55 and a wall barrier flat portion 57. The first projection 50 and the second projection 55 are interconnected to each other by the wall barrier flat portion 57, thereby defining a covering space. Further, the first projection 50 of the covering wall barrier portion 30 partially encloses the first sidewall 35 of the pair of sidewalls, and the second projection 55 of the covering wall barrier portion 30 partially encloses the second sidewall 40 of the pair of sidewalls. The wall barrier flat portion 57 of the covering wall barrier portion 30 is connected to an outer circumference surface of the taco shell base 45 at a distal end of the taco style shell 60, thereby forming the defined space for maintaining the taco and other ingredients therebetween.

In yet another embodiment of the present invention, a taco style shell for maintaining taco and other ingredients within a defined space includes a partially circular shell forming portion being foldable about a midline thereof and sealed at a distal end of the taco shell, thereby forming the defined space for maintaining the taco and other ingredients therebetween. Further, a proximal end of the taco style shell is open.

Therefore, as it may be seen, various embodiments of the present invention illustrate and describe taco style shells, which provide better structural integrity and an improved appearance to the taco shell over previously developed taco shells. Moreover, the present invention taco style shell provides improved ergonomic fit relative to a user's hand.

Those of ordinary skill in the art will appreciate that though in different views of various embodiments, an exemplary taco style shell is illustrated, the actual shape, texture, thickness, hardness and size of the taco shell may vary for various commercial embodiments of the present invention, depending upon needs of the consumer.

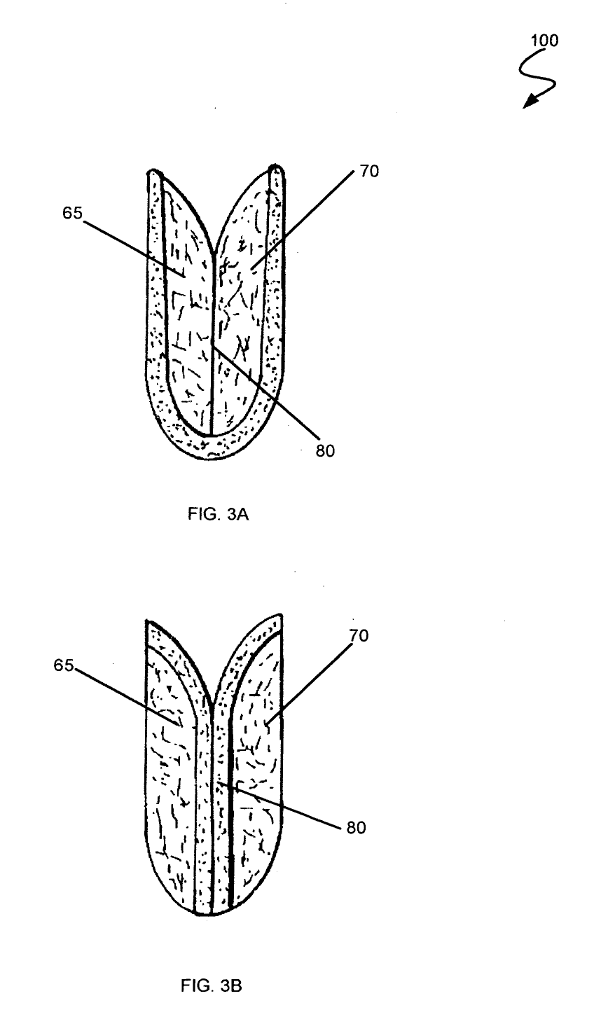

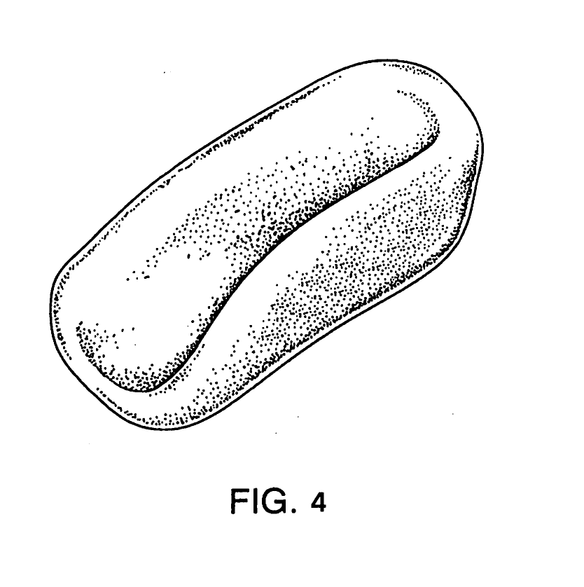

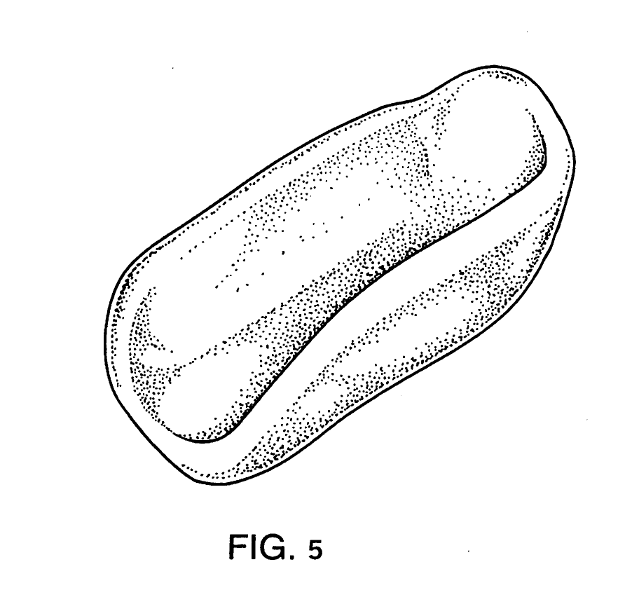

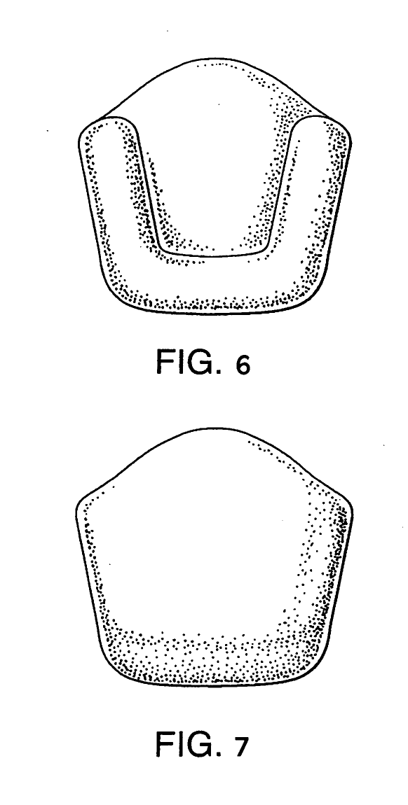

Shown in FIGS. 4-7 are further embodiments that show a pita or other puffy bread comestible may be used as the shell of the inventive taco. In the embodiment of FIGS. 5-7, the rear wall is higher that the embodiment of FIG. 4. Such bread may be light, heavy, airy or blistered.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. A taco style shell for maintaining taco and other food ingredients within a defined space, said taco style shell comprising:
a pair of spaced apart sidewalls, said pair of sidewalls comprising a first sidewall and a second sidewall integrally connected by a taco shell base; and
an end wall integral with said taco shell base, said first sidewall and said second sidewall, thereby forming said defined space for maintaining said taco and other food ingredients therebetween.

2. A taco style shell for maintaining taco and other food ingredients within a defined space, said taco style shell comprising:
a pair of spaced apart sidewalls, said pair of sidewalls comprising a first sidewall and a second sidewall interconnected by a taco shell base; and
a covering wall barrier portion comprising a first projection, a second projection and an end wall, said first projection and said second projection interconnected to each other by said end wall, defining a covering space, said first projection of said covering wall barrier portion partially enclosing said first sidewall of said pair of sidewalls, and said second projection of said covering wall barrier portion partially enclosing said second sidewall of said pair of sidewall and, said end of said covering wall barrier portion integral to an outer surface of said taco shell base at a distal end of said taco style shell, thereby forming said defined space for maintaining said taco and other food ingredients therebetween.

3. A taco style shell for maintaining taco and other food ingredients within a defined space, said taco style shell comprising a partially circular shell forming portion being foldable about a midline thereof and sealed at a distal end of said taco style shell, thereby forming said defined space for maintaining said taco and other food ingredients therebetween.

4. The taco style shell as recited in claim 3, wherein a proximal end of said taco style shell is open.

5. The taco style shell as recited in claim 1, said shell comprising corn, wheat or other flours.

6. The taco style shell as recited in claim 1, in which said shell is hard or soft, thick or thin

7. The taco style shell as recited in claim 3 having one end closed by means of pinching, cutting or folding, one peace molding, injection and other molding techniques.

8. The taco style shell as recited in claim 1, in which said shell comprises a puffy pita bread-like comestible.

9. The taco style shell as recited in claim 2, in which said shell comprises a puffy pita bread-like comestible.

10. The taco style shell as recited in claim 3, in which said shell comprises a puffy pita bread-like comestible.
